(19) United States
(12) Patent Application Publication
(10) Pub. No.: US 2025/0095926 A1
(43) Pub. Date: Mar. 20, 2025

(54) Mechanical Load-Bearing Supercapacitor and Electrode Having Cement-Spaced Graphene Sheets and Production Process

(71) Applicant: Nanotek Instruments Group, LLC, Dayton, OH (US)

(72) Inventor: Bor Z. Jang, Centerville, OH (US)

(73) Assignee: Nanotek Instruments Group, LLC, Dayton, OH (US)

(21) Appl. No.: 18/470,816

(22) Filed: Sep. 20, 2023

(51) Int. Cl. H01G 11/26; H01G 11/32; H01G 11/48

(52) U.S. Cl. CPC H01G 11/26; H01G 11/32; H01G 11/48

(57) ABSTRACT

Provided is a supercapacitor comprising an anode, a cathode, an ion-permeable separator disposed between said anode and said cathode, and an electrolyte in ionic contact with said anode and said cathode, wherein at least one of the anode and the cathode comprises 0.001% to 95% by weight of multiple graphene sheets spaced by or dispersed in cement and said multiple graphene sheets, when measured alone without cement, have a specific surface area from 50 to 3,300 m²/g. The electrode may further comprise a carbon or graphite material selected from natural graphite, artificial graphite, expanded graphite, meso-phase carbon, meso-phase pitch, meso-carbon micro-bead, soft carbon, hard carbon, coke, carbon fiber, carbon nano-fiber, carbon nano-tube, activated carbon, carbon black, acetylene black, or a combination thereof. Also provided is such a supercapacitor electrode (anode or cathode) and a process for producing an electrode for such a supercapacitor.

### FIELD

The present invention relates generally to the field of supercapacitors and, more particularly, to a graphene-based load-bearing electrode, a load-bearing (or structural) supercapacitor containing such an electrode, and a process for producing same.

### BACKGROUND

Electrochemical capacitors (ECs), also known as ultracapacitors or supercapacitors, are being considered for uses in hybrid electric vehicles (EVs) where they can supplement a battery used in an electric car to provide bursts of power needed for rapid acceleration, the biggest technical hurdle to making battery-powered cars commercially viable. A battery would still be used for cruising, but supercapacitors (with their ability to release energy much more quickly than batteries) would kick in whenever the car needs to accelerate for merging, passing, emergency maneuvers, and hill climbing. The EC must also store sufficient energy to provide an acceptable driving range. To be cost-, volume-, and weight-effective compared to additional battery capacity they must combine adequate energy densities (volumetric and gravimetric) and power densities (volumetric and gravimetric) with long cycle life, and meet cost targets as well.

ECs are also gaining acceptance in the electronics industry as system designers become familiar with their attributes and benefits. ECs were originally developed to provide large bursts of driving energy for orbital lasers. In complementary metal oxide semiconductor (CMOS) memory backup applications, for instance, a one-Farad EC having a volume of only one-half cubic inch can replace nickel-cadmium or lithium batteries and provide backup power for months. For a given applied voltage, the stored energy in an EC associated with a given charge is half that storable in a corresponding battery system for passage of the same charge. Nevertheless, ECs are extremely attractive power sources. Compared with batteries, they require no maintenance, offer much higher cycle-life, require a very simple charging circuit, experience no “memory effect,” and are generally much safer. Physical rather than chemical energy storage is the key reason for their safe operation and extraordinarily high cycle-life. Perhaps most importantly, capacitors offer higher power density than batteries.

The high volumetric capacitance density of an EC relative to conventional capacitors (10 to 100 times greater than conventional capacitors) derives from using porous electrodes to create a large effective “plate area” and from storing energy in the diffuse double layer. This double layer, created naturally at a solid-electrolyte interface when voltage is imposed, has a thickness of only about 1 nm, thus forming an extremely small effective “plate separation.” Such a supercapacitor is commonly referred to as an electric double layer capacitor (EDLC). The double layer capacitor is based on a high surface area electrode material, such as activated carbon, immersed in a liquid electrolyte. A polarized double layer is formed at electrode-electrolyte interfaces providing high capacitance. This implies that the specific capacitance of a supercapacitor is directly proportional to the specific surface area of the electrode material. This surface area must be accessible by electrolyte and the resulting interfacial zones must be sufficiently large to accommodate the so-called electric double-layer charges.

In some ECs, stored energy is further augmented by pseudo-capacitance effects, occurring again at the solid-electrolyte interface due to electrochemical phenomena such as the redox charge transfer. Such a supercapacitor is commonly referred to as a pseudo-capacitor or redox supercapacitor. A third type of supercapacitor is a lithium-ion capacitor that contains a pre-lithiated graphite anode, an EDLC cathode (e.g. typically based on activated carbon particles), and a lithium salt electrolyte.

However, there are several serious technical issues associated with current state-of-the-art supercapacitors:
(1) Experience with supercapacitors based on activated carbon electrodes shows that the experimentally measured capacitance is always much lower than the geometrical capacitance calculated from the measured surface area and the width of the dipole layer. For very high surface area activated carbons, typically only about 20-40 percent of the “theoretical” capacitance was observed. This disappointing performance is related to the presence of micro-pores (<2 nm, mostly <1 nm) and ascribed to inaccessibility of some pores by the electrolyte, wetting deficiencies, and/or the inability of a double layer to form successfully in pores in which the oppositely charged surfaces are less than about 1-2 nm apart. In activated carbons, depending on the source of the carbon and the heat treatment temperature, a surprising amount of surfaces can be in the form of such micro-pores that are not accessible to liquid electrolyte.
(2) Despite the high gravimetric capacitances at the electrode level (based on active material weights alone) as frequently claimed in open literature and patent documents, these electrodes unfortunately fail to provide energy storage devices with high capacities at the supercapacitor cell or pack level (based on the total cell weight or pack weight). This is due to the notion that, in these reports, the actual mass loadings of the electrodes and the apparent densities for the active materials are too low. In most cases, the active material mass loadings of the electrodes (areal density) is significantly lower than 10 mg/cm² (areal density=the amount of active materials per electrode cross-sectional area along the electrode thickness direction) and the apparent volume density or tap density of the active material is typically less than 0.75 g/cm³ (more typically less than 0.5 g/cm³ and most typically less than 0.3 g/cm⁻³) even for relatively large particles of activated carbon.

The low mass loading is primarily due to the inability to obtain thicker electrodes (thicker than 150 μm) using the conventional slurry coating procedure. This is not a trivial task as one might think, and in reality the electrode thickness is not a design parameter that can be arbitrarily and freely varied for the purpose of optimizing the cell performance. Contrarily, thicker samples tend to become extremely brittle or of poor structural integrity and would also require the use of large amounts of binder resin. These problems are particularly acute for graphene material-based electrodes. It has not been previously possible to produce graphene-based electrodes that are thicker than 100 μm and remain highly porous with pores remaining fully accessible to liquid electrolyte. The low areal densities and low volume densities (related to thin electrodes and poor packing density) result in relatively low volumetric capacitances and low volumetric energy density of the supercapacitor cells.

With the growing demand for more compact and portable energy storage systems, there is keen interest to increase the utilization of the volume of the energy storage devices. Novel electrode materials and designs that enable high volumetric capacitances and high mass loadings are essential to achieving improved cell volumetric capacitances and energy densities.
(3) During the past decade, much work has been conducted to develop electrode materials with increased volumetric capacitances utilizing porous carbon-based materials, such as graphene, carbon nanotube-based composites, porous graphite oxide, and porous meso carbon. Although these experimental supercapacitors featuring such electrode materials can be charged and discharged at high rates and also exhibit large volumetric electrode capacitances (50 to 150 F/cm³ in most cases, based on the electrode volume), their typical active mass loading of <1 mg/cm², tap density of <0.2 g/cm³, and electrode thicknesses of up to tens of micrometers (<<100 μm) are still significantly lower than those used in most commercially available electrochemical capacitors (i.e. 10 mg/cm², 100-200 μm), which results in energy storage devices with relatively low areal and volumetric capacitances and low volumetric energy densities.
(4) For graphene-based supercapacitors, there are additional problems that remain to be solved, explained below:

Nano graphene materials have recently been found to exhibit exceptionally high thermal conductivity, high electrical conductivity, and high strength. Another outstanding characteristic of graphene is its exceptionally high specific surface area. A single graphene sheet provides a specific external surface area of approximately 2,675 m²/g (that is accessible by liquid electrolyte), as opposed to the exterior surface area of approximately 1,300 m²/g provided by a corresponding single-wall CNT (interior surface not accessible by electrolyte). The electrical conductivity of graphene is slightly higher than that of CNTs.

The applicant and his colleagues were the first to investigate graphene- and other nano graphite-based nano materials for supercapacitor application [Please see Refs.1-5 below; the 1^{st} patent application was submitted in 2006 and issued in 2009]. After 2008, researchers began to realize the significance of graphene materials for supercapacitor applications.

### LIST OF REFERENCES

1. Lulu Song, A. Zhamu, Jiusheng Guo, and B. Z. Jang “Nano-scaled Graphene Plate Nanocomposites for Supercapacitor Electrodes” U.S. Pat. No. 7,623,340 (Nov. 24, 2009).
2. Aruna Zhamu and Bor Z. Jang, “Process for Producing Nano-scaled Graphene Platelet Nanocomposite Electrodes for Supercapacitors,” U.S. Pat. No. 7,875,219 (Jan. 25, 2011).
3. Aruna Zhamu and Bor Z. Jang, “Graphite-Carbon Composite Electrodes for Supercapacitors” U.S. Pat. No. 7,948,739 (Apr. 24, 2011).
4. Aruna Zhamu and Bor Z. Jang, “Method of Producing Graphite-Carbon Composite Electrodes for Supercapacitors” U.S. Pat. No. 8,497,225 (Jul. 30, 2013).
5. Aruna Zhamu and Bor Z. Jang, “Graphene Nanocomposites for Electrochemical cell Electrodes,” U.S. Pat. No. 9,190,667 (Nov. 17, 2015).

However, individual nano graphene sheets have a great tendency to re-stack themselves, effectively reducing the specific surface areas that are accessible by the electrolyte in a supercapacitor electrode. The significance of this graphene sheet overlap issue may be illustrated as follows: For a nano graphene platelet with dimensions of/(length)×w (width)×t (thickness) and density p, the estimated surface area per unit mass is S/m=(2/ρ)(1/l+1/w+1/t). With p=2.2 g/cm³, l=100 nm, w=100 nm, and t=0.34 nm (single layer), we have an impressive S/m value of 2,675 m²/g, which is much greater than that of most commercially available carbon black or activated carbon materials used in the state-of-the-art supercapacitor. If two single-layer graphene sheets stack to form a double-layer graphene, the specific surface area is reduced to 1,345 m²/g. For a three-layer graphene, t=1 nm, we have S/m=906 m²/g. If more layers are stacked together, the specific surface area would be further significantly reduced.

These calculations suggest that it is critically important to find a way to prevent individual graphene sheets from re-stacking and, even if they partially re-stack, the resulting multi-layer structure would still have inter-layer pores of adequate sizes. These pores must be sufficiently large to allow for accessibility by the electrolyte and to enable the formation of electric double-layer charges, which presumably require a pore size of at least 1-2 nm. However, these pores or inter-graphene spacings must also be sufficiently small to ensure a large tap density (hence, large capacitance per unit volume or large volumetric energy density). To a great extent, the requirement to have large pore sizes and high porosity level and the requirement to have a high tap density are considered mutually exclusive in supercapacitors.

Another major technical barrier to using graphene sheets as a supercapacitor electrode active material is the challenge of forming a thick active material layer onto the surface of a solid current collector (e.g. Al foil) using the conventional graphene-solvent slurry coating process. In such an electrode, the graphene electrode typically requires a large amount of a binder resin (hence, significantly reduced active material proportion vs. non-active or overhead materials/components). In addition, any graphene electrode prepared in this manner that is thicker than 50 μm is brittle and weak. There has been no effective solution to these problems.

In a supercapacitor electrode, activated carbon particles or graphene sheets, as an electrode active material, are typically bonded by a resin or polymer binder. Due to the typically inadequate mechanical strength of a polymer, the resulting supercapacitor electrode cannot be used as a load-bearing structure. Cement or concrete containing cement as a binder is known to be the most commonly used ingredient in a large-scale structure, such as a building and a bridge. Owing to their excellent mechanical performance and durability, graphene oxide/cement composites (GO/CCs) exhibit good potential for the development of long-life green concrete. Previous studies have demonstrated that the uniform dispersion of GO in a cement matrix can lead to significant enhancements in the compressive strength, flexural strength, and tensile strength of cement composites, and it can also improve the resistance of corrosive media and sensitive resistance-strain responses. Hence, GO/CCs are a promising cement-based material with high performance, good structural compatibility, and long service life. Many scholars have investigated the incorporation of graphene materials into concrete for improving mechanical properties, durability, electrical conductivity, thermal conductivity, pressure sensitivity, and thermal energy absorption. However, it has not been disclosed or suggested that graphene materials can be a multi-functional ingredient in a supercapacitor electrode that not only provides mechanical strength but also imparts energy storage capability to a cement or concrete structure. The extent and pace of the transition from current fossil fuel-based economy to one that is based on renewable energy will depend on the availability of bulk energy storage solutions. Large-scale concrete/cement structure-based supercapacitors that are structurally sound can help accelerate such a critically important transition.

Therefore, there is a clear need for cement/concrete-based structural supercapacitors which serve not only as an energy storage device but also as a structural element in an infrastructure or building, such as an autarchic shelter. For graphene-based electrodes, one must also overcome problems such as re-stacking of graphene sheets.

### SUMMARY

The present invention provides a structural (load-bearing) supercapacitor comprising an optional ion-permeable separator disposed between the anode and the cathode, and an electrolyte in ionic contact with the anode and the cathode, wherein at least one of the anode and the cathode contains 0.001% to 95% by weight of multiple graphene sheets that are spaced by or dispersed in cement or concrete and said multiple graphene sheets, when measured alone without cement and concrete, have a specific surface area from 50 to 3,300 m²/g and preferably form a 3D network of electron-conducting pathways. Preferably, graphene sheets occupy a weight fraction from 0.01% to 50%, and more preferably from 0.1% to 30%.

The graphene sheets may be selected from a pristine graphene having a 99% to 100% carbon content, a non-pristine graphene material, or a combination thereof wherein the non-pristine graphene has a content of non-carbon elements from 1% to 50% by weight and is selected from graphene oxide, reduced graphene oxide, graphene fluoride, graphene chloride, graphene bromide, graphene iodide, hydrogenated graphene, hydroxylated graphene, nitrogenated graphene, chemically functionalized graphene, doped graphene, or a combination thereof.

The cement may be selected from ordinary Portland cement (OPC), Portland pozzolana cement (PPC), rapid-hardening cement, extra-rapid-hardening cement, quick-setting cement, low-heat cement, sulfate-resisting cement, blast furnace slag cement, high-alumina cement, white cement, colored cement, air-entraining cement, expansive cement, hydrographic cement, Portland-limestone cement (PLC), or a combination thereof.

The concrete may be selected from Normal Strength Concrete, Reinforced Concrete, Plain or Ordinary Concrete, Prestressed Concrete, Precast Concrete, Lightweight Concrete, High-Density Concrete, Stamped Concrete, Air-Entrained Concrete, Ready-Mix Concrete, Self-Consolidated Concrete, Volumetric Concrete, Decorative Concrete, Polymer Concrete, Rapid-Set Concrete, Smart Concrete, Pervious Concrete, Vacuum Concrete, Pumped Concrete, Limecrete, Roll Compacted Concrete, Glass Concrete, Asphalt Concrete, Shotcrete Concrete, High-Strength Concrete, High-Performance Concrete, or a combination thereof.

In certain preferred embodiments, the supercapacitor exhibits at least one of the features below: (i) at least one of the anode and the cathode is porous and has a specific surface area of from 50 m²/g to 2,000 m²/g; (ii) at least one of the anode and the cathode has pores that are interconnected or are conducive to permeation of liquid electrolyte and the electrolyte is present in the pores; (iii) the multiple graphene sheets meet or exceed a percolation threshold defined by a threshold weight percentage or volume percentage at and above which the graphene sheets form a 3D network of interconnected electron-conducting paths; and (iv) at least one of the anode and the cathode comprises particles or fibers of a non-graphene conductive additive and the multiple graphene sheets, in combination with the conductive additive, meet or exceed a percolation threshold defined by a threshold weight percentage or volume percentage of the conductive additive and graphene combined at and above which the graphene sheets and the conductive additive particles or fibers together form a 3D network of interconnected electron-conducting paths.

In certain embodiments, the supercapacitor comprises a pseudo-capacitor or redox capacity, wherein the graphene sheets are deposited with a nano-scaled coating or particles of a redox pair partner selected from an intrinsically conductive polymer, a transition metal oxide, and/or an organic molecule, wherein the redox pair partner and said graphene sheets form a redox pair for pseudo-capacitance. Preferably, the intrinsically conducting polymer is selected from polyaniline, polypyrrole, polythiophene, polyfuran, sulfonated polyaniline, sulfonated polypyrrole, sulfonated polythiophene, sulfonated polyfuran, sulfonated polyacetylene, or a combination thereof.

The electrolyte may contain an aqueous electrolyte, an organic electrolyte, a polymer gel electrolyte, a solid polymer electrolyte, an inorganic electrolyte, an ionic liquid electrolyte, or a mixture thereof.

Preferably, the electrolyte contains an aqueous electrolyte comprising an ion-forming substance dissolved in water, wherein the ion-forming substance is selected from KOH, KCl, H₂SO₄, NaClO₄, Na₂SO₄, a combination thereof, or a combination thereof with a redox active substance. The redox active substance may be selected from the group consisting of iron-based organic complexes, quinones, viologens, phenazines, phenothiazines, 2,2,6,6-tetramethyl-1-piperidinyloxy (TEMPO) derivatives, azobenzenes, alloxazines, and combinations thereof.

The supercapacitor may further comprise an anode current collector in electronic contact with the anode or a cathode current collector in electronic contact with the cathode.

Preferably, in the invented supercapacitor, both the anode and the cathode contain graphene sheets spaced by cement or concrete and both electrodes are porous having a specific surface area from 50 to 2,000 m²/g.

In certain embodiments, at least one of the anode and the cathode further comprises a carbon or graphite material selected from natural graphite, artificial graphite, expanded graphite, meso-phase carbon, meso-phase pitch, meso-carbon micro-bead, soft carbon, hard carbon, coke, carbon fiber, carbon nano-fiber, carbon nano-tube, activated carbon, carbon black, acetylene black, or a combination thereof and wherein the sum of graphene sheets and the carbon or graphite material is from 1.0% to 95% by weight (preferably 1% to 30% and further preferably from 5% to 20%) of the electrode.

The disclosure also discloses a supercapacitor electrode containing 0.001% to 95% by weight of multiple graphene sheets that are spaced by or dispersed in a cement or concrete and the graphene sheets, when measured alone without the presence of cement or concrete, have a specific surface area from 50 to 3,300 m²/g (preferably at least 500 m²/g, and more preferably at least 1,500 m²/g) and these graphene sheets preferably form a 3D network of electron-conducting pathways.

In some preferred embodiments, the electrode exhibits at least one of the features below: (i) the electrode is porous and has a specific surface area of from 50 m²/g to 2,000 m²/g; (ii) the electrode has pores that are interconnected or are conducive to permeation of liquid electrolyte and the electrolyte is present in the pores; (iii) the multiple graphene sheets meet or exceed a percolation threshold defined by a threshold weight percentage or volume percentage at and above which the graphene sheets form a 3D network of interconnected electron-conducting paths; and (iv) the electrode comprises particles or fibers of a non-graphene conductive additive and the multiple graphene sheets, in combination with the conductive additive, meet or exceed a percolation threshold defined by a threshold weight percentage or volume percentage of the conductive additive and graphene combined at and above which the graphene sheets and the conductive additive particles or fibers together form a 3D network of interconnected electron-conducting paths.

In certain embodiments, the supercapacitor electrode further contains a liquid or gel electrolyte residing in a space between graphene sheets or residing in pores of the electrode.

The graphene sheets in the electrode are preferably selected from a pristine graphene (essentially 0% non-carbon elements) or a non-pristine graphene material (having a content of non-carbon elements from 1% to 50% by weight) selected from graphene oxide, reduced graphene oxide, graphene fluoride, graphene chloride, graphene bromide, graphene iodide, hydrogenated graphene, hydroxylated graphene, nitrogenated graphene, chemically functionalized graphene, doped graphene, or a combination thereof.

In certain embodiments, the graphene sheets are deposited with a nano-scaled coating or particles of a redox pair partner selected from an intrinsically conductive polymer, a transition metal oxide, and/or an organic molecule, wherein said redox pair partner and said graphene sheets form a redox pair for pseudo-capacitance. The intrinsically conducting polymer may be selected from polyaniline, polypyrrole, polythiophene, polyfuran, sulfonated polyaniline, sulfonated polypyrrole, sulfonated polythiophene, sulfonated polyfuran, sulfonated polyacetylene, or a combination thereof.

The electrode preferably further comprises a carbon or graphite material selected from natural graphite, artificial graphite, expanded graphite, meso-phase carbon, meso-phase pitch, meso-carbon micro-bead, soft carbon, hard carbon, coke, carbon fiber, carbon nano-fiber, carbon nano-tube, activated carbon, carbon black, acetylene black, or a combination thereof and wherein the sum of graphene sheets and the carbon or graphite material is from 1.0% to 95% (preferably 1% to 30% and further preferably from 5% to 20%) by weight of the electrode.

The present disclosure also provides a process of producing the aforementioned supercapacitor, the process comprising a) dispersing multiple graphene sheets, a desired amount of cement or concrete, an optional conductive additive, and an optional resin binder in a liquid medium to form a graphene slurry; b) dispensing and depositing the graphene slurry onto a surface of a solid substrate or a current collector and forming a wet graphene/cement or graphene/concrete layer thereon which is optionally subjected to a compression treatment to align graphene sheets along a desired direction; and c) at least partially removing the liquid medium from the wet graphene/cement or graphene/concrete layer to form a dry graphene/cement or graphene/concrete layer wherein multiple graphene sheets are spaced by the cement or concrete to form the supercapacitor electrode.

The process may further comprise combining the supercapacitor electrode, a second electrode, and an electrolyte to form a supercapacitor cell.

In certain embodiments, the graphene slurry in the process contains a graphene oxide dispersion that is prepared by immersing a graphitic material in a powder or fibrous form in an oxidizing liquid in a reaction vessel at a reaction temperature for a length of time sufficient to obtain said graphene dispersion wherein said graphitic material is selected from natural graphite, artificial graphite, meso-phase carbon, meso-phase pitch, meso-carbon micro-bead, soft carbon, hard carbon, coke, carbon fiber, carbon nano-fiber, carbon nano-tube, or a combination thereof and wherein said graphene oxide has an oxygen content no less than 5% by weight.

### BRIEF DESCRIPTION OF THE DRAWINGS

FIG. 1(A) A flow chart illustrating various prior art processes of producing exfoliated graphite products (flexible graphite foils and expanded graphite flakes) and graphene sheets;

FIG. 1(B) Schematic drawing illustrating the processes for producing conventional paper, mat, film, and membrane of simply aggregated graphite or graphene sheets. All processes begin with intercalation and/or oxidation treatment of graphitic materials (e.g. natural graphite particles).

FIG. 2 Schematic of a conventional activated carbon-based supercapacitor cell.

FIG. 3(A) Schematic drawing to illustrate a structural supercapacitor electrode comprising graphene sheets dispersed in a cement or concrete matrix wherein these multiple graphene sheets form a 3D network of electron-conducting pathways, according to certain embodiments of the present disclosure;

FIG. 3(B) Schematic drawing to illustrate a structural supercapacitor electrode comprising graphene sheets and conductive additive particles dispersed in a cement or concrete matrix wherein these multiple graphene sheets, coupled with conductive additive particles, form a 3D network of electron-conducting pathways, according to certain embodiments of the present disclosure.

FIG. 4 Schematic drawing to illustrate a structural supercapacitor, according to certain embodiments of the present disclosure.

FIG. 5 Electric conductivity vs. weight percentage of graphene sheets and carbon black (CB) in graphene/cement composite and CB/cement composite electrodes, respectively.

### DETAILED DESCRIPTION

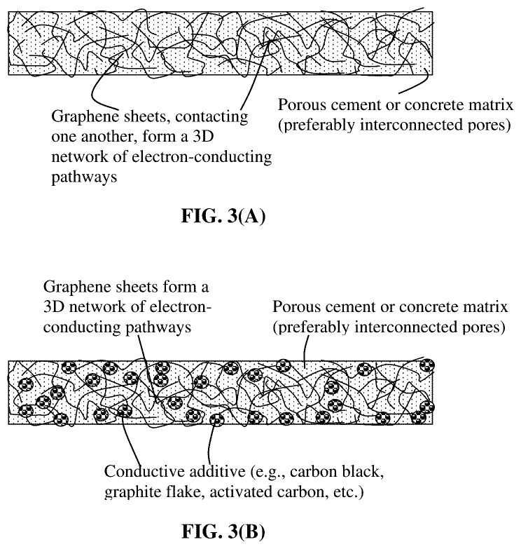

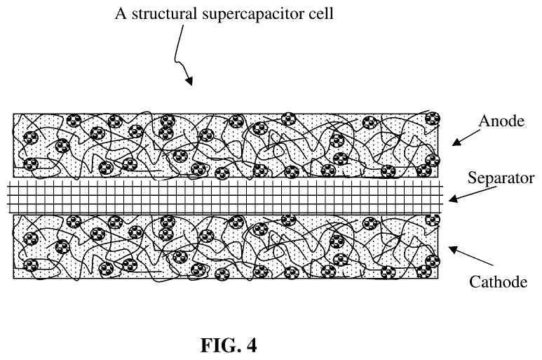

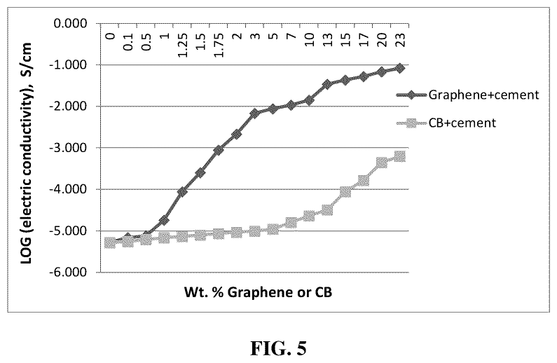

The present invention provides a structural (load-bearing) supercapacitor comprising an optional ion-permeable separator disposed between the anode and the cathode, and an electrolyte in ionic contact with the anode and the cathode, wherein at least one of the anode and the cathode contains 0.001% to 95% by weight of multiple graphene sheets that are spaced by or dispersed in cement or concrete and said multiple graphene sheets, when measured alone without cement and concrete, have a specific surface area from 50 to 3,300 m²/g and wherein preferably these graphene sheets form a 3D network of electron-conducting pathways (FIG. 4). Preferably, graphene sheets occupy a weight fraction from 0.01% to 50%, and more preferably from 0.1% to 30%. Two examples of the anode or cathode are illustrated in FIG. 3(A) and FIG. 3(B).

Preferably, the supercapacitor exhibits at least one of the features below: (i) at least one of the anode and the cathode is porous and has a specific surface area of from 50 m²/g to 2,000 m²/g; (ii) at least one of the anode and the cathode has pores that are interconnected or are conducive to permeation of liquid electrolyte and the electrolyte is present in the pores; (iii) the multiple graphene sheets meet or exceed a percolation threshold defined by a threshold weight percentage or volume percentage at and above which the graphene sheets form a 3D network of interconnected electron-conducting paths; and (iv) at least one of the anode and the cathode comprises particles or fibers of a non-graphene conductive additive and the multiple graphene sheets, in combination with the conductive additive, meet or exceed a percolation threshold defined by a threshold weight percentage or volume percentage of the conductive additive and graphene combined at and above which the graphene sheets and the conductive additive particles or fibers together form a 3D network of interconnected electron-conducting paths.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were recently reviewed by us [Bor Z. Jang and A Zhamu, “Processing of Nano Graphene Platelets (NGPs) and NGP Nanocomposites: A Review,” J. Materials Sci. 43 (2008) 5092-5101].

For the purpose of defining the claims of the instant application, graphene materials (or nano graphene platelets, NGPs) include discrete sheets/platelets of single-layer and multi-layer (typically less than 10 layers) pristine graphene, graphene oxide, reduced graphene oxide (RGO), graphene fluoride, graphene chloride, graphene bromide, graphene iodide, hydrogenated graphene, hydroxylated graphene, nitrogenated graphene, chemically functionalized graphene, doped graphene (e.g. doped by B or N). Pristine graphene has essentially 0% oxygen; some pristine graphene may have up to 1% by weight of non-carbon elements. Pristine graphene is produced by a process not involving oxidation of graphite, for instance. RGO typically has an oxygen content of 0.001%-5% by weight. Graphene oxide (including RGO) can have 0.001%-50% by weight of oxygen. Other than pristine graphene, all the graphene materials have 0.001%-50% by weight of non-carbon elements (e.g. O, H, N, B, F, Cl, Br, I, etc.). These materials are herein referred to as non-pristine graphene materials. The production of various types of graphene sheets will be discussed in later portion of this section.

The electrode structure, composition, and production processes for conventional supercapacitors are herein briefly discussed with the primary issues or problems identified:

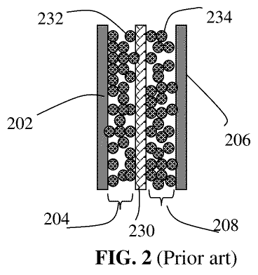

As schematically illustrated in FIG. 2, a prior art supercapacitor cell is typically composed of an anode current collector 202 (e.g. Al foil 12-15 μm thick), an anode active material layer 204 (containing an anode active material, such as activated carbon particles 232 and conductive additives that are bonded by a resin binder, such as polyvinylidene fluoride or PVDF and styrene-butadiene rubber or SBR), a porous separator 230, a cathode active material layer 208 (containing a cathode active material, such as activated carbon particles 234, and conductive additives that are all bonded by a resin binder, not shown), a cathode current collector 206 (e.g. Al foil), and a liquid electrolyte disposed in both the anode active material layer 204 (also simply referred to as the “anode layer”) and the cathode active material layer 208 (or simply “cathode layer”). The entire cell is encased in a protective housing, such as a thin plastic-aluminum foil laminate-based envelope. The prior art supercapacitor cell is typically made by a process that includes the following steps:
a) The first step is mixing particles of the anode active material (e.g. activated carbon), a conductive filler (e.g. graphite flakes), a resin binder (e.g. PVDF) in a solvent (e.g. NMP) to form an anode slurry. On a separate basis, particles of the cathode active material (e.g. activated carbon), a conductive filler (e.g. acetylene black), a resin binder (e.g. PVDF) are mixed and dispersed in a solvent (e.g. NMP) to form a cathode slurry.
b) The second step includes coating the anode slurry onto one or both primary surfaces of an anode current collector (e.g. Cu or Al foil), drying the coated layer by vaporizing the solvent (e.g. NMP) to form a dried anode electrode coated on Cu or Al foil. Similarly, the cathode slurry is coated and dried to form a dried cathode electrode coated on Al foil.
c) The third step includes laminating an anode/Al foil sheet, a porous separator layer, and a cathode/Al foil sheet together to form a 3-layer or 5-layer assembly, which is cut and slit into desired sizes and stacked to form a rectangular structure (as an example of shape) or rolled into a cylindrical cell structure.
d) The rectangular or cylindrical laminated structure is then encased in a laminated aluminum-plastic envelope or steel casing.
e) A liquid electrolyte is then injected into the laminated housing structure to make a supercapacitor cell.

There are several serious problems associated with this conventional process and the resulting supercapacitor cell:
1) It is very difficult to produce an electrode layer (anode layer or cathode layer) that is thicker than 100 μm and practically impossible or impractical to produce an electrode layer thicker than 200 μm. There are several reasons why this is the case. The conventional process requires dispersing electrode active materials (anode active material and cathode active material) in a liquid solvent (e.g. NMP) to make a wet slurry and, upon coating on a current collector surface, the liquid solvent has to be removed to dry the electrode layer. An electrode of 100 μm thickness typically requires a heating zone of 30-50 meters long in a slurry coating facility, which is too time consuming, too energy intensive, and not cost-effective. A heating zone longer than 100 meters is often utilized to remove the liquid medium such as NMP.
2) Current supercapacitors (e.g. symmetric supercapacitors or electric double layer capacitors, EDLC) still suffer from a relatively low gravimetric energy density and low volumetric energy density. Graphene sheets make an excellent active material, but conventional graphene-based EDLCs also suffer from low specific capacitance due to the low specific surface area caused by re-stacking of graphene sheets.
3) The extent and pace of the transition from current fossil fuel-based economy to one that is based on renewable energy will depend on the availability of large-scale bulk energy storage solutions. Current supercapacitors that are typically encased in a laminated plastic-aluminum housing or cylindrical steel casing are not conducive to the formation large-scale supercapacitor cells. In order to make a supercapacitor-based energy storage system, one must connect a large number of cells together in parallel and/or in series to make a large-scale module or pack.

The present disclosure includes a structural or load-bearing supercapacitor that can contain large-scale anode and cathode; there are no theoretical limitations on the dimensions of the electrodes. The supercapacitor can be an integral part of a large-scale structure (e.g., a building wall, etc.). Further, the supercapacitor cell does not have to be encased in a protective housing.

In certain embodiments, the supercapacitor comprises an anode, a cathode, an ion-permeable separator disposed between the anode and the cathode, and an electrolyte in ionic contact with the anode and the cathode, wherein at least one of the anode and the cathode contains multiple graphene sheets spaced by cement or concrete and these graphene sheets have a specific surface area from 50 to 3,300 m²/g. The cement or concrete prevents graphene sheets from restacking, which otherwise would lead to reduction in the specific surface area and, hence, specific capacitance. The amount of graphene sheets must be sufficient to reach or exceed a percolation threshold in a cement or concrete matrix; i.e., the graphene sheets alone or in combination with other conductive fillers must form a 3D network of electron-conducting pathways in the matrix. This percolation threshold is typically reached with a graphene weight percentage of 0.01% to 10% in a cement or concrete matrix, more typically from 0.1% to 5%. This threshold depends on the dimensions of graphene sheets (e.g., length-to-thickness aspect ratio) and type of cement or concrete. Single-layer graphene sheets are preferred over multi-layer graphene sheets. The length or width of graphene sheets is preferably in the range of 0.3 to 10 μm.

There are no restrictions on the types of cement that one can use as a matrix to disperse graphene sheets. Here are 15 types of cement that can be used: Ordinary Portland cement (OPC), Portland pozzolana cement (PPC), Rapid-hardening cement, Extra-rapid-hardening cement, Quick-setting cement. Low-heat cement, Sulfate-resisting cement, Blast furnace slag cement, High-alumina cement, White cement, Colored cement, Air-entraining cement, Expansive cement, Hydrographic cement, Portland-limestone cement (PLC), or a combination thereof.

Ordinary Portland cement is the most widely used type of cement manufactured and used worldwide. “Portland” is a generic name derived from a type of building stone quarried on the Isle of Portland in Dorset, England. OPC is suitable for most general concrete tasks and mortar or stucco construction projects. Manufacturers create Portland pozzolana cement (PPC) by grinding pozzolanic clinker, sometimes with additives of gypsum or calcium sulfate, with ordinary Portland cement. Compared to OPC, PPC has a higher resistance to various chemical reactions within concrete. PPC is often used for building bridges, piers, dams, marine structures, sewage works, or underwater concrete projects.

One may choose to use rapid-hardening cement for its high strength in the early stages of the hardening process. Its strength in three days is comparable to OPC strength at seven days with the same water-to-cement ratio. Rapid-hardening cement may have an increased lime content, combined with a finer grinding process, or better strength development. We have observed that the use of certain graphene sheets can significantly reduce the cement hardening time, from typically 2-4 weeks to typically less than 1 week.

Extra-rapid-hardening cement may set and become durable even faster than OPC and rapid-hardening cement. This can be achieved by adding calcium chloride to rapid-hardening cement. This cement type may be useful for cold-weather concrete projects due to its fast setting rate. In some cases, such extra-rapid-hardening practice may compromise the strengths of the resulting cement; this problem can be reduced or eliminated by using graphene sheets. Graphene sheets can reduce the amount of calcium chloride and can significantly enhance the mechanical properties of this type of cement.

Similar to extra-rapid-hardening cement, this concrete type may set and become stronger even quicker than OPC and rapid-hardening cement, particularly when used in combination with graphene sheets. Its grain and strength rate are similar to OPC, but it hardens faster. Quick-setting cement may be beneficial for time-sensitive projects or those located near stagnant or running water.

Low-heat cement is typically manufactured by monitoring the percentage of tricalcium aluminate in the mixture to ensure it stays below 6% of the whole. This approach helps maintain low heat during the hydration process, making this cement type more resistant to sulfates and less reactive than other types of cement. This may be suitable for mass concrete construction or projects to help prevent cracking due to heat. However, low-heat cement may have a longer initial setting time than other types; this issue can be addressed by using some graphene sheets, which not only reduces the hardening time but helps to dissipate the heat.

For all types of cement, the presence of graphene sheets can significantly increase the mechanical properties, reduce the cement hardening time, and alleviate any heat-related issues. For the production of supercapacitors, graphene sheets can serve as an anode active material that is capable storing a high amount of charges.

Similarly, there are no theoretical limitations on the types of concrete that can be used to produce the presently disclosed structural supercapacitor electrodes and cells. The concrete may be selected from Normal Strength Concrete, Reinforced Concrete, Plain or Ordinary Concrete, Prestressed Concrete, Precast Concrete, Lightweight Concrete, High-Density Concrete, Stamped Concrete, Air-Entrained Concrete, Ready-Mix Concrete, Self-Consolidated Concrete, Volumetric Concrete, Decorative Concrete, Polymer Concrete, Rapid-Set Concrete, Smart Concrete, Pervious Concrete, Vacuum Concrete, Pumped Concrete, Limecrete, Roll Compacted Concrete, Glass Concrete, Asphalt Concrete, Shotcrete Concrete, High-Strength Concrete, High-Performance Concrete, or a combination thereof.

In a preferred embodiment, the graphene material in the supercapacitor electrode is selected from pristine graphene, graphene oxide, reduced graphene oxide, graphene fluoride, graphene chloride, graphene bromide, graphene iodide, hydrogenated graphene, hydroxylated graphene, nitrogenated graphene, chemically functionalized graphene, doped graphene, or a combination thereof. The starting graphitic material for producing any one of the above graphene materials may be selected from natural graphite, artificial graphite, meso-phase carbon, meso-phase pitch, meso-carbon micro-bead, soft carbon, hard carbon, coke, carbon fiber, carbon nano-fiber, carbon nano-tube, or a combination thereof.

For instance, the graphene oxide (GO) may be obtained by immersing powders or filaments of a starting graphitic material (e.g. natural graphite powder) in an oxidizing liquid medium (e.g. a mixture of sulfuric acid, nitric acid, and potassium permanganate) in a reaction vessel at a desired temperature for a period of time (typically from 0.5 to 96 hours, depending upon the nature of the starting material and the type of oxidizing agent used). The resulting graphite oxide particles may then be subjected to thermal exfoliation or ultrasonic wave-induced exfoliation to produce GO sheets.

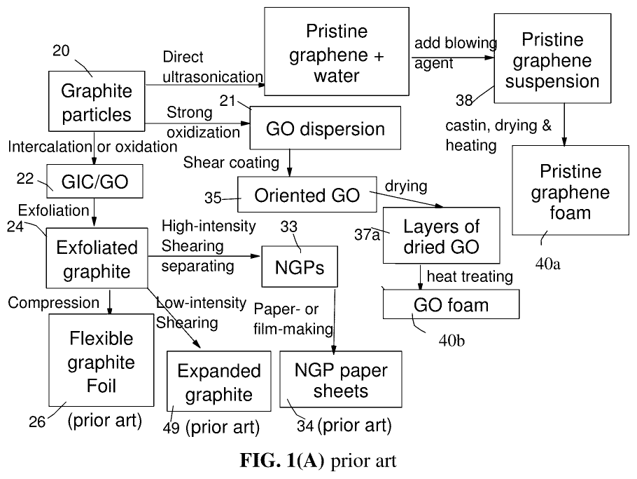

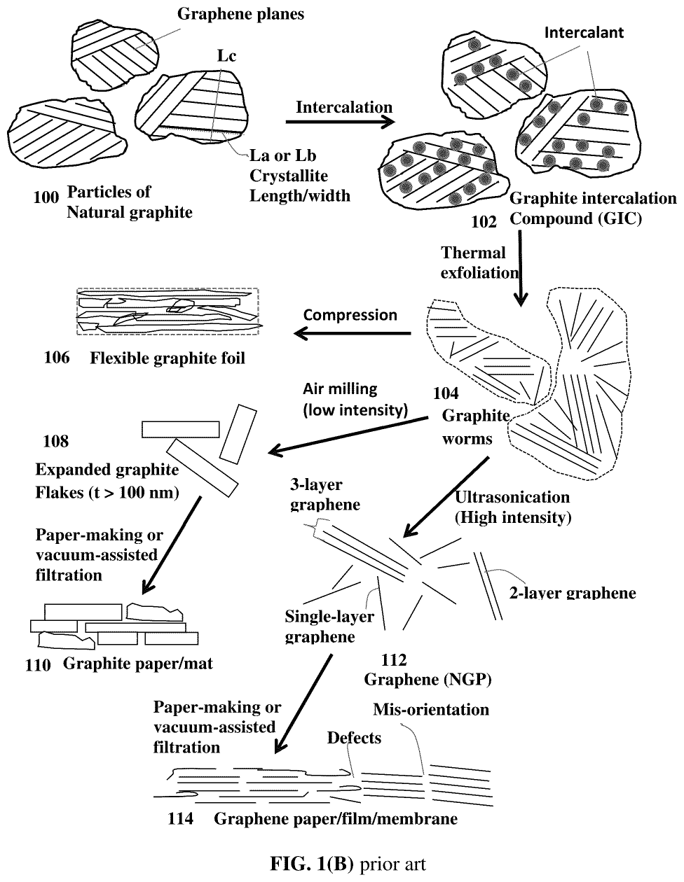

Pristine graphene may be produced by direct ultrasonication (also known as liquid phase production) or supercritical fluid exfoliation of graphite particles. These processes are well-known in the art. Multiple pristine graphene sheets may be dispersed in water or other liquid medium with the assistance of a surfactant to form a suspension. A chemical blowing agent may then be dispersed into the dispersion (38 in FIG. 1(A)). This suspension is then cast or coated onto the surface of a solid substrate (e.g. glass sheet or Al foil). When heated to a desired temperature, the chemical blowing agent is activated or decomposed to generate volatile gases (e.g. N₂ or CO₂), which act to form bubbles or pores in an otherwise mass of solid graphene sheets, forming a pristine graphene foam 40a.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated including of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

The aforementioned features are further described and explained in detail as follows: As illustrated in FIG. 1(B), a graphite particle (e.g. 100) is typically composed of multiple graphite crystallites or grains. A graphite crystallite is made up of layer planes of hexagonal networks of carbon atoms. These layer planes of hexagonally arranged carbon atoms are substantially flat and are oriented or ordered so as to be substantially parallel and equidistant to one another in a particular crystallite. These layers of hexagonal-structured carbon atoms, commonly referred to as graphene layers or basal planes, are weakly bonded together in their thickness direction (crystallographic c-axis direction) by weak van der Waals forces and groups of these graphene layers are arranged in crystallites. The graphite crystallite structure is usually characterized in terms of two axes or directions: the c-axis direction and the a-axis (or b-axis) direction. The c-axis is the direction perpendicular to the basal planes. The a- or b-axes are the directions parallel to the basal planes (perpendicular to the c-axis direction).

A highly ordered graphite particle can consist of crystallites of a considerable size, having a length of Lₐ along the crystallographic a-axis direction, a width of L_{b} along the crystallographic b-axis direction, and a thickness L_{c} along the crystallographic c-axis direction. The constituent graphene planes of a crystallite are highly aligned or oriented with respect to each other and, hence, these anisotropic structures give rise to many properties that are highly directional. For instance, the thermal and electrical conductivity of a crystallite are of great magnitude along the plane directions (a- or b-axis directions), but relatively low in the perpendicular direction (c-axis). As illustrated in the upper-left portion of FIG. 1(B), different crystallites in a graphite particle are typically oriented in different directions and, hence, a particular property of a multi-crystallite graphite particle is the directional average value of all the constituent crystallites.

Due to the weak van der Waals forces holding the parallel graphene layers, natural graphite can be treated so that the spacing between the graphene layers can be appreciably opened up so as to provide a marked expansion in the c-axis direction, and thus form an expanded graphite structure in which the laminar character of the carbon layers is substantially retained. The process for manufacturing flexible graphite is well-known in the art. In general, flakes of natural graphite (e.g. 100 in FIG. 1(B)) are intercalated in an acid solution to produce graphite intercalation compounds (GICs, 102). The GICs are washed, dried, and then exfoliated by exposure to a high temperature for a short period of time. This causes the flakes to expand or exfoliate in the c-axis direction of the graphite up to 80-300 times of their original dimensions. The exfoliated graphite flakes are vermiform in appearance and, hence, are commonly referred to as worms 104. These worms of graphite flakes which have been greatly expanded can be formed without the use of a binder into cohesive or integrated sheets of expanded graphite, e.g. webs, papers, strips, tapes, foils, mats or the like (typically referred to as “flexible graphite” 106) having a typical density of about 0.04-2.0 g/cm³ for most applications.

The upper left portion of FIG. 1(A) shows a flow chart that illustrates the prior art processes used to fabricate flexible graphite foils. The processes typically begin with intercalating graphite particles 20 (e.g., natural graphite or synthetic graphite) with an intercalant (typically a strong acid or acid mixture) to obtain a graphite intercalation compound 22 (GIC). After rinsing in water to remove excess acid, the GIC becomes “expandable graphite.” The GIC or expandable graphite is then exposed to a high temperature environment (e.g., in a tube furnace preset at a temperature in the range of 800-1,050° C.) for a short duration of time (typically from 15 seconds to 2 minutes). This thermal treatment allows the graphite to expand in its c-axis direction by a factor of 30 to several hundreds to obtain a worm-like vermicular structure 24 (graphite worm), which contains exfoliated, but un-separated graphite flakes with large pores interposed between these interconnected flakes.

In one prior art process, the exfoliated graphite (or mass of graphite worms) is re-compressed by using a calendaring or roll-pressing technique to obtain flexible graphite foils (26 in FIG. 1(A) or 106 in FIG. 1(B)), which are typically 100-300 μm thick. In another prior art process, the exfoliated graphite worm 24 may be impregnated with a resin and then compressed and cured to form a flexible graphite composite, which is normally of low strength as well. In addition, upon resin impregnation, the electrical and thermal conductivity of the graphite worms could be reduced by two orders of magnitude.

Alternatively, the exfoliated graphite may be subjected to high-intensity mechanical shearing/separation treatments using a high-intensity air jet mill, high-intensity ball mill, or ultrasonic device to produce separated nano graphene platelets 33 (NGPs) with all the graphene platelets thinner than 100 nm, mostly thinner than 10 nm, and, in many cases, being single-layer graphene (also illustrated as 112 in FIG. 1(B)). An NGP is composed of a graphene sheet or a plurality of graphene sheets with each sheet being a two-dimensional, hexagonal structure of carbon atoms. A mass of multiple NGPs (including discrete sheets/platelets of single-layer and/or few-layer graphene or graphene oxide, 33 in FIG. 1(A)) may be made into a graphene film/paper (34 in FIG. 1(A) or 114 in FIG. 1(B)) using a film- or paper-making process.

Further alternatively, with a low-intensity shearing, graphite worms tend to be separated into the so-called expanded graphite flakes (108 in FIG. 1(B) having a thickness >100 nm. These flakes can be formed into graphite paper or mat 106 using a paper- or mat-making process. This expanded graphite paper or mat 106 is just a simple aggregate or stack of discrete flakes having defects, interruptions, and mis-orientations between these discrete flakes.

The isolated graphene sheets may be further subjected to the following treatments, separately or in combination, prior to being dispersed in the electrolyte:
(a) Being chemically functionalized or doped with atomic, ionic, or molecular species. Useful surface functional groups may include quinone, hydroquinone, quaternized aromatic amines, mercaptans, or disulfides. This class of functional groups can impart pseudo-capacitance to graphene-based supercapacitors.
(b) coated or grafted with an intrinsically conductive polymer (conducting polymers, such as polyacetylene, polypyrrole, polyaniline, polythiophene, and their derivatives, are good choices for use in the present invention); These treatments are intended for further increasing the capacitance value through pseudo-capacitance effects such as redox reactions.
(c) deposition with transition metal oxides or sulfides, such as RuO₂, TiO₂, MnO₂, Cr₂O₃, and Co₂O₃, for the purpose of forming redox pairs with graphene sheets, thereby imparting pseudo-capacitance to the electrode; and
(d) subjected to an activation treatment (analogous to activation of carbon black materials) to create additional surfaces and possibly imparting functional chemical groups to these surfaces. The activation treatment can be accomplished through CO₂ physical activation, KOH chemical activation, or exposure to nitric acid, fluorine, or ammonia plasma.

In the instant invention, there is no limitation on the type of liquid or gel electrolytes that can be used in the supercapacitor: aqueous, organic, gel, and ionic liquid. Typically, electrolytes for supercapacitors include solvent and dissolved chemicals (e.g. salts) that dissociate into positive ions (cations) and negative ions (anions), making the electrolyte electrically conductive. The more ions the electrolyte contains, the better its conductivity, which also influences the capacitance. In supercapacitors, the electrolyte provides the molecules for the separating monolayer in the Helmholtz double-layer (electric double layer) and delivers the ions for pseudocapacitance.

Water is a relatively good solvent for dissolving inorganic chemicals. When added together with acids such as sulfuric acid (H₂SO₄), alkalis such as potassium hydroxide (KOH), or salts such as quaternary phosphonium salts, sodium perchlorate (NaClO₄), lithium perchlorate (LiClO₄) or lithium hexafluoride arsenate (LiAsF₆), water offers relatively high conductivity values. Aqueous electrolytes have a dissociation voltage of 1.15 V per electrode and a relatively low operating temperature range. Water electrolyte may further comprise a redox active substance.

Organic redox-active molecules have high element abundance, minimal environmental impacts, and potentially low cost. Their redox center(s) commonly is/are oxygen, nitrogen, carbon, or sulfur atom(s). The structural diversity and designability of organic redox-active materials enable the high tunability of physical and chemical properties, for example, solubility, stability, and redox potential. The organic redox species are mainly classified into iron-based organic complexes, such as ferrocene, quinones, viologens, phenazines, phenothiazines, 2,2,6,6-tetramethyl-1-piperidinyloxy (TEMPO) derivatives, azobenzenes, alloxazines, and combinations thereof. Among them, the most studied organic redox species are ferrocene, TEMPO, quinone, viologen, and phenazine derivatives. Further, aqueous electrolytes composed of water and simple inorganic supporting electrolytes, in combination with well-developed selective ion-conductive membranes, have many advantages, such as high safety, low cost, and high conductivity.

Alternatively, electrolytes may contain organic solvents, such as acetonitrile, propylene carbonate, tetrahydrofuran, diethyl carbonate, γ-butyrolactone, and solutes with quaternary ammonium salts or alkyl ammonium salts such as tetraethylammonium tetrafluoroborate (N(Et)₄BF₄) or triethyl (methyl) tetrafluoroborate (NMe(Et)₃BF₄). Organic electrolytes are more expensive than aqueous electrolytes, but they have a higher dissociation voltage of typically 1.35 V per electrode (2.7 V capacitor voltage), and a higher temperature range. The lower electrical conductivity of organic solvents (10 to 60 mS/cm) leads to a lower power density, but a higher energy density since the energy density is proportional to the square of the voltage.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane) sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2,3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2,3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a supercapacitor.

In order to make a pseudo-capacitor (a supercapacitor that works on the development of pseudo-capacitance through redox pair formation), the anode active material or cathode active material may be designed to contain graphene sheets and a redox pair partner material selected from a metal oxide, a conducting polymer (e.g. conjugate-chain polymers), a non-conducting polymer (e.g. polyacrylonitrile, PAN), an organic material (e.g. hydroquinone), a non-graphene carbon material, an inorganic material, or a combination thereof. Many of the materials that can pair up with reduced graphene oxide sheets are well-known in the art. In this study, we have come to realize that graphene halogenide (e.g. graphene fluoride), graphene hydrogenide, and nitrogenated graphene can work with a wide variety of partner materials to form a redox pair for developing pseudo-capacitance.

For instance, the metal oxide or inorganic materials that serve in such a role include RuO₂, IrO₂, NiO, MnO₂, VO₂, V₂O₅, V₃O₈, TiO₂, Cr₂O₃, Co₂O₃, Co₃O₄, PbO₂, Ag₂O, MoCx, Mo₂N, or a combination thereof. In general, the inorganic material may be selected from a metal carbide, metal nitride, metal boride, metal dichalcogenide, or a combination thereof. Preferably, the desired metal oxide or inorganic material is selected from an oxide, dichalcogenide, trichalcogenide, sulfide, selenide, or telluride of niobium, zirconium, molybdenum, hafnium, tantalum, tungsten, titanium, vanadium, chromium, cobalt, manganese, iron, or nickel in a nanowire, nano-disc, nano-ribbon, or nano platelet form.

In certain embodiments, at least one of the anode and the cathode further comprises a carbon or graphite material selected from natural graphite, artificial graphite, expanded graphite, meso-phase carbon, meso-phase pitch, meso-carbon micro-bead, soft carbon, hard carbon, coke, carbon fiber, carbon nano-fiber, carbon nano-tube, activated carbon, carbon black, acetylene black, or a combination thereof and wherein the sum of graphene sheets and the carbon or graphite material is from 1.0% to 95% by weight (preferably 1% to 30% and further preferably from 5% to 20%) of the electrode.

Due to a 2D geometric feature and a high length/width-to-thickness ratio of graphene sheets, a supercapacitor can readily reach or exceed a percolation threshold that forms a 3D network of electron-conducting pathways. Typically and preferably, the 3D network of electron-conducting pathways reaches surfaces of an electrode (e.g., the two primary surfaces of an electrode layer, as schematically illustrated in FIGS. 3(A) and 3(B)).

As schematically illustrated in FIG. 3(A), the disclosure also discloses a supercapacitor electrode containing 0.001% to 95% by weight of multiple graphene sheets that are spaced by or dispersed in a cement or concrete and the graphene sheets, when measured alone without the presence of cement or concrete, have a specific surface area from 50 to 3,300 m²/g, preferably at least 500 m²/g, and more preferably at least 1,500 m²/g. These graphene sheets preferably form a 3D network of electron-conducting pathways.

Preferably, the electrode exhibits at least one of the features below: (i) the electrode is porous and has a specific surface area of from 50 m²/g to 2,000 m²/g; (ii) the electrode has pores that are interconnected or are conducive to permeation of liquid electrolyte and the electrolyte is present in the pores; (iii) the multiple graphene sheets meet or exceed a percolation threshold defined by a threshold weight percentage or volume percentage at and above which the graphene sheets form a 3D network of interconnected electron-conducting paths; and (iv) the electrode comprises particles or fibers of a non-graphene conductive additive and the multiple graphene sheets, in combination with the conductive additive, meet or exceed a percolation threshold defined by a threshold weight percentage or volume percentage of the conductive additive and graphene combined at and above which the graphene sheets and the conductive additive particles or fibers together form a 3D network of interconnected electron-conducting paths.

In some embodiments, the electrode (anode and/or cathode) is porous, having pores that are either interconnected or are conducive to permeation of a liquid electrolyte, enabling the liquid electrolyte to migrate into pores and make physical contact with graphene sheets and the conductive additive (e.g., carbon and graphite particles or fibers), if present.

In certain embodiments, the supercapacitor electrode further contains a liquid or gel electrolyte residing in a space between graphene sheets.

The graphene sheets in the electrode are preferably selected from a pristine graphene or a non-pristine graphene material, having a content of non-carbon elements from 1% to 50% by weight, selected from graphene oxide, reduced graphene oxide, graphene fluoride, graphene chloride, graphene bromide, graphene iodide, hydrogenated graphene, hydroxylated graphene, nitrogenated graphene, chemically functionalized graphene, doped graphene, or a combination thereof.

In certain embodiments, the graphene sheets are deposited with a nano-scaled coating or particles of a redox pair partner selected from an intrinsically conductive polymer, a transition metal oxide, and/or an organic molecule, wherein said redox pair partner and said graphene sheets form a redox pair for pseudo-capacitance. The intrinsically conducting polymer may be selected from polyaniline, polypyrrole, polythiophene, polyfuran, sulfonated polyaniline, sulfonated polypyrrole, sulfonated polythiophene, sulfonated polyfuran, sulfonated polyacetylene, or a combination thereof.

The electrode preferably may further comprise a carbon or graphite material selected from natural graphite, artificial graphite, expanded graphite, meso-phase carbon, meso-phase pitch, meso-carbon micro-bead, soft carbon, hard carbon, coke, carbon fiber, carbon nano-fiber, carbon nano-tube, activated carbon, carbon black, acetylene black, or a combination thereof and wherein the sum of graphene sheets and the carbon or graphite material is from 1.0% to 95% (preferably 1% to 30% and further preferably from 5% to 20%) by weight of the electrode. The graphene sheets, in combination with the conducting additive (carbon or graphite material). form a 3D network of electron-conducting pathways, as schematically illustrated in FIG. 3(B).

The present disclosure also discloses a process of producing the aforementioned supercapacitor, the process comprising a) dispersing multiple graphene sheets, a desired amount of cement or concrete, an optional conductive additive (e.g., a carbon or graphite material in particulate or fibrous form), and an optional resin binder in a liquid medium to form a graphene slurry; b) dispensing and depositing the graphene slurry onto a surface of a solid substrate or a current collector and forming a wet graphene/cement or graphene/concrete layer thereon which is optionally subjected to a compression treatment to align graphene sheets along a desired direction; and c) at least partially removing the liquid medium from the wet graphene/cement or graphene/concrete layer to form a dry graphene/cement or graphene/concrete layer wherein multiple graphene sheets are spaced by or dispersed in the cement or concrete to form the supercapacitor electrode.

The process may further comprise combining and assembling the supercapacitor electrode (e.g., an anode), a second electrode (e.g., a cathode), and an electrolyte to form a supercapacitor cell. A separator layer of an electrically insulating material may be used to electrically separate the anode from the cathode. The separator is typically a porous layer that is permeable to a liquid electrolyte. The separator may be just a layer of porous cement or concrete containing no electron-conducting species such as graphene and carbon black. The anode, the cathode, and the separator may be soaked in a liquid electrolyte (e.g., KCl in water) before or after the combining/assembling step.

In certain embodiments, the graphene slurry in the process contains a graphene oxide dispersion that is prepared by immersing a graphitic material in a powder or fibrous form in an oxidizing liquid in a reaction vessel at a reaction temperature for a length of time sufficient to obtain a graphene dispersion wherein the graphitic material is selected from natural graphite, artificial graphite, meso-phase carbon, meso-phase pitch, meso-carbon micro-bead, soft carbon, hard carbon, coke, carbon fiber, carbon nano-fiber, carbon nano-tube, or a combination thereof and wherein said graphene oxide has an oxygen content no less than 5% by weight. This graphene dispersion is then mixed with a desired amount of cement or concrete.

The following examples are used to illustrate some specific details about the best modes of practicing the instant invention and should not be construed as limiting the scope of the invention.

### Example 1: Preparation of Graphene/Cement Supercapacitor Electrodes and Cells Fro Isolated Reduced Graphene Oxide (RGO) Sheets

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 5-16 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, five grams of the graphite oxide fibers were mixed with 2,000 ml alcohol solution including alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%-31% by weight. The resulting suspension contains GO sheets being suspended in water. The suspension was dried and the resulting GO sheets were thermally reduced at 300° C. for 24 hours to obtain reduced graphene oxide (RGO) sheets.

Cement mortar was prepared by mixing cement, sand, water, and RGO sheets (0-15% of graphite flakes, activated carbon, and/or carbon black particles). The water-to-cement ratio was kept at 0.5. Graphene was incorporated in the cement mortar at several different percentages, from 0.1 wt % to 23 wt % based on the composite weight.

For cement mortar containing RGO sheets, dried graphene was wiped through a set of five sieves with the finest mesh sieve size being 250 μm. Graphene and cement were stirred sufficiently at low speed (˜140 rpm) using a hand mixer to obtain a homogenous dry mixture. Water was added to cement with graphene and the mixer was immediately started at low speed for 30 s. Subsequently, the mixer was stopped to remove all the mortar adhered to the walls of the bowl and then mixing was continued at high speed for 60 s. For samples containing graphite flakes, activated carbon, or carbon black, these carbon/graphite particles were also added to cement prior to pouring water. All resulting cement composites were placed into steel cylindrical molds with the diameter of 60 mm and the height of 120 mm. Cement mortar was placed in the molds in a few layers and each layer was subjected to vibration on a vibration table for 1 min to ensure the compaction of the composite. All specimens were immediately covered by polyethylene foil to prevent loss of water. After 24 h, the hardened cement mortar samples were demolded and continued to be cured in water at 20° C. All cylindrical samples were dried in the air for 24 h before performing electrical, mechanical, and electrochemical tests.

Each cylindrical sample was cut with a diamond saw into multiple pieces having a typical thickness from 1.2 to 4.5 mm. The electrical conductivity of discs containing different RGO proportions were measured and plotted into a curve of conductivity vs. RGO proportion (e.g., FIG. 5). The percolation threshold was determined when the conductivity curve exhibits an abrupt increase (typically by 1-3 orders of magnitude). This is a well-known method in the field of composite materials. The data presented in FIG. 5 indicates that the graphene/cement composite reaches a percolation threshold at approximately 1.5% by weight of RGO. In contrast, the carbon black (CB)/cement composite reaches a percolation threshold at approximately 17% by weight of CB. Furthermore, the graphene/cement composite electrodes exhibit significantly higher electric conductivity as compared with the CB/cement composite essentially at all weight percentages.

Two pieces of electrodes each of approximately 2.15 mm in thickness, spaced by a porous cement-sand separator, were laminated to form a supercapacitor cell. The cell was soaked in a liquid electrolyte bath (containing 1.2 M of KCl dissolved in water) for 24 hours to make a symmetric EDLC graphene/cement supercapacitor cell.

The electrochemical performance of supercapacitor cells was measured according to the procedure described in Example 2 below. We have observed that the specific capacitance values of our graphene/cement-based structural supercapacitors are typically in the range of 45 to 56 F/g (on the basis of graphene mass). The specific capacitance values of carbon black/cement-based supercapacitors are typically in the range of 1.2 to 19.3 F/g (per CB mass) and those of activated carbon/cement-based supercapacitors in the range of 11.3 to 24.5 F/g (per activated carbon mass).

### EXAMPLE 2: Details about Electrochemical Performance Evaluation of Various Supercapacitor Cells

In most of the examples investigated, both the inventive structural supercapacitor cells (comprising a cement or concrete matrix, spacer, or binder) and their conventional counterparts (comprising a polymer binder) were fabricated and evaluated. The latter cells, for comparison purposes, were prepared by the conventional procedures of slurry coating of electrodes, drying of electrodes, assembling of anode layer, separator, and cathode layer, packaging of assembled laminate, and injection of liquid electrolyte. In a conventional cell, an electrode (cathode or anode), is typically composed of 85% an electrode active material (e.g. graphene, activated carbon, inorganic nano discs, etc.), 5% Super-P (acetylene black-based conductive additive), and 10% PTFE as a resin binder, which were mixed and coated on Al foil. The thickness of the conventional electrode is around 100 μm. For each sample, both coin-size and pouch cells were assembled. The capacity was measured with galvanostatic experiments using an Arbin SCTS electrochemical testing instrument. Cyclic voltammetry (CV) and electrochemical impedance spectroscopy (EIS) were conducted on an electrochemical workstation (CHI 660 System, USA).

Galvanostatic charge/discharge tests were conducted on the samples to evaluate the electrochemical performance. For the galvanostatic tests, the specific capacity (q) is calculated as

$$q = I * t / m \qquad ( 1 )$$

where I is the constant current in mA, t is the time in hours, and m is the cathode active material mass in grams. With voltage V, the specific energy (E) is calculated as,

$$E = \int Vdq \qquad ( 2 )$$

The specific power (P) can be calculated as

$$P = ( E / t ) ( W / kg ) \qquad ( 3 )$$

where t is the total charge or discharge step time in hours.
The specific capacitance (C) of the cell is represented by the slope at each point of the voltage vs. specific capacity plot,

$$C = dq / dV \qquad ( 4 )$$

For each sample, several current density (representing charge/discharge rates) were imposed to determine the electrochemical responses, allowing for calculations of energy density and power density values required of the construction of a Ragone plot (power density vs. energy density).

### Example 3: Preparation of Structural Supercapacitors Comprising Single-Layer Graphene Sheets Prepared from Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

Regular strength concrete powder, along with graphene sheets and 2% by weight KCl particles, were mixed in a mixing pan and then placed in a mold. Slight compaction was used to remove air from fresh concrete. The concrete was covered with a layer of water in the mold, so it stays moist. By keeping concrete moist during curing, the bond between the cement paste and the aggregates could get stronger. The specimen was removed from the mold 24 hours after casting. Specimen were cut into thinner pieces (<2 mm in thickness), which were placed immediately in an aqueous electrolyte solution including 1 M of KCl in water after removal from the mold. Two pieces and a porous cement layer separating these two were then made into a supercapacitor cell.

### Example 4: Preparation of Structural Supercapacitors Comprising Pristine Graphene (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene supercapacitor having a higher electrical conductivity and lower equivalent series resistance. Pristine graphene sheets were produced by using the direct ultrasonication process (also called the liquid-phase exfoliation process).

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W(Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

The pristine graphene sheets were then made into supercapacitor electrodes and supercapacitor cells, following a similar procedure described in Example 1.

### Example 5: Preparation of Structural Supercapacitors Comprising Graphene Oxide (GO) from Natural Graphite

Graphite oxide was prepared by oxidation of graphite flakes with an oxidizer liquid including sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions using ultrasonication. The suspension containing 5% of GO sheets were then spray-dried to form isolated GO sheets, which was thermally reduced at 1,500° C. for 1 hour. Some of these GO sheets were then dispersed in a slurry of cement, fine sand particles, and water to form several slurry samples. He slurry was then cast into a mold to form a slab.

### Example 6: Preparation of Structural Supercapacitors Comprising Graphene Fluoride (GF)

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but longer sonication lengths of time ensured better stability. Some of these GF sheets, along with a desired amount of cement, were made into supercapacitor, following a similar procedure described in Example 1.

### Example 7: Preparation of Structural Supercapacitors Comprising Nitrogenataed Graphene Dispersed in a Cement Matrix

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene/urea mass ratios of 1:0.5, 1:1 and 1:2, respectively and the nitrogen contents of these samples were 14.7, 18.2 and 17.5 wt %, respectively as determined by elemental analysis. These nitrogenataed graphene sheets remain dispersible in water. The resulting suspensions were then added with a Na₂SO₄ salt and some deionized water to produce a 1M aqueous solution of Na₂SO₄ (as an aqueous electrolyte). Various amounts of cement were added into the dispersion, followed by casting into a mold.

### Example 8: Preparation of Structural Supercapacitor Cells Comprising Intrinsically Conductive Polymer-Graphene Redox Pairs Dispersed in a Porous Cement Matrix

In this series of examples, intrinsically conductive polymers (e.g. polyaniline, poly polypyrrole, and polythiophene) and their sulfonated versions are evaluated for their effectiveness as a redox pair partner material with a graphene material.

The chemical synthesis of the sulfonated polyaniline (S-PANi) was accomplished by reacting polyaniline with concentrated sulfuric acid. The procedure was similar to that used by Epstein, et al. (U.S. Pat. No. 5,109,070, Apr. 28, 1992). The resulting S-PANi can be represented by the following Formula 1, with R₁, R₂, R₃, and R₄ group being H, SO₃⁻ or SO₃H (R₅=H) with the content of the latter two being varied between 30% and 75% (i.e., the degree of sulfonation varied between 30% and 75%).

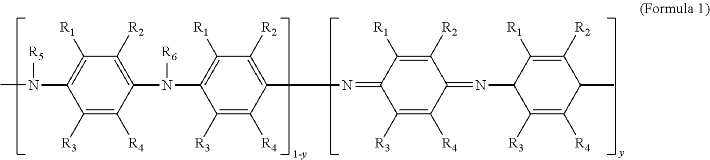

The electron conductivity of these SO₃⁻ or SO₃H-based S-PANi compositions was in the range of 0.1 S/cm to 0.5 S/cm when the degree of sulfonation was from approximately 30% to 75% (with y being approximately 0.4-0.6). The S-PANi/water solution was mixed with GO/water solution at a S-PANi/GO weight ratio of ⅕-½ and, upon water removal, the S-PANi was precipitated out and coated onto the graphene sheets for forming a redox pair. The polymer-coated graphene sheets were then mixed with cement (15% by weight) as a binder and made into pseudo-capacitance electrodes using both the presently invented process and the conventional process.

A sulfonated pyrrole-based polymer (with X=NH and Y=SO₃, m=1, and A=H in the following formula) was synthesized by following a procedure adapted from Aldissi, et al., U.S. Pat. No. 4,880,508, Nov. 14, 1989.

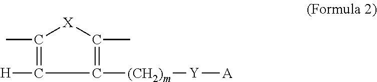

For solution impregnation, as one example, approximately 5.78 g of the resulting sulfonated polypyrrole was dissolved in 100 ml of distilled water. Then, the aqueous solution was mixed with GO/water solution and the resulting liquid mixture was dried to allow for precipitation and deposition of sulfonated polypyrrole onto surfaces of graphene sheets to form a redox pair. Conductive polymer-coated graphene sheets were then bonded by cement/water and made into pseudo-capacitance.

The sulfonated conductive polymer (e.g. S-PANi), paired up with a graphene material and dispersed in a mement matrix, leads to a significantly higher pseudo-capacitance value when compared with the corresponding material prepared by using graphene sheets alone; e.g. 237 F/g (based on S-PANi/graphene weight) vs. 46 F/g (based on graphene weight).

### Example 9: Preparation of Structural Supercapacitor Cells Comprising MnO₂-Graphene Redox Pairs Dispersed in a Cement Matrix

The MnO₂ powder was synthesized in the presence of pristine graphene, with or without cellulose nanofibers. In this method, a 0.1 mol/L KMnO₄ aqueous solution was prepared by dissolving potassium permanganate in deionized water. Meanwhile 13.3 g surfactant of high purity sodium bis(2-ethylhexyl) sulfosuccinate was added in 300 mL iso-octane (oil) and stirred well to obtain an optically transparent solution. Then, 32.4 mL of 0.1 mol/L KMnO₄ solution were added in the solution, which was followed by dispersing pristine graphene sheets in the solution. The resulting suspension was ultrasonicated for 30 min and a dark brown precipitate of MnO₂ was coated on surfaces of graphene sheets. The products were recovered, washed several times with distilled water and ethanol, and dried at 80° C. for 12 h. The samples were MnO₂-coated graphene sheets, which were re-dispersed into a cement/water dispersion and cast into a mold. Upon completion of hardening, the sample was sliced into thin discs and made into structural supercapacitor cells. In such a structure, graphene and MnO₂ form a redox pair operating to produce pseudo-capacitance in a supercapacitor.

1. A supercapacitor comprising an anode, a cathode, and an electrolyte in ionic contact with said anode and said cathode, wherein at least one of the anode and the cathode contains 0.001% to 95% by weight of multiple graphene sheets that are spaced by or dispersed in cement or concrete and said multiple graphene sheets, when measured alone without cement and concrete, have a specific surface area from 50 to 3,300 m²/g.

2. The supercapacitor of claim 1, wherein said graphene sheets are selected from a pristine graphene having a 99% to 100% carbon content, a non-pristine graphene material, or a combination thereof wherein the non-pristine graphene has a content of non-carbon elements from 1% to 50% by weight and is selected from graphene oxide, reduced graphene oxide, graphene fluoride, graphene chloride, graphene bromide, graphene iodide, hydrogenated graphene, hydroxylated graphene, nitrogenated graphene, chemically functionalized graphene, doped graphene, or a combination thereof.

3. The supercapacitor of claim 1, wherein said cement is selected from ordinary Portland cement (OPC), Portland pozzolana cement (PPC), rapid-hardening cement, extra-rapid-hardening cement, quick-setting cement, low-heat cement, sulfate-resisting cement, blast furnace slag cement, high-alumina cement, white cement, colored cement, air-entraining cement, expansive cement, hydrographic cement, Portland-limestone cement (PLC), or a combination thereof.

4. The supercapacitor of claim 1, wherein said concrete is selected from Normal Strength Concrete, Reinforced Concrete, Plain or Ordinary Concrete, Prestressed Concrete, Precast Concrete, Lightweight Concrete, High-Density Concrete, Stamped Concrete, Air-Entrained Concrete, Ready-Mix Concrete, Self-Consolidated Concrete, Volumetric Concrete, Decorative Concrete, Polymer Concrete, Rapid-Set Concrete, Smart Concrete, Pervious Concrete, Vacuum Concrete, Pumped Concrete, Limecrete, Roll Compacted Concrete, Glass Concrete, Asphalt Concrete, Shotcrete Concrete, High-Strength Concrete, High-Performance Concrete, or a combination thereof.

5. The supercapacitor of claim 1, wherein said supercapacitor exhibits at least one of the features below: (i) at least one of the anode and the cathode is porous and has a specific surface area of from 50 m²/g to 2,000 m²/g; (ii) at least one of the anode and the cathode has pores that are interconnected or are conducive to permeation of liquid electrolyte and the electrolyte is present in the pores; (iii) the multiple graphene sheets meet or exceed a percolation threshold defined by a threshold weight percentage or volume percentage at and above which the graphene sheets form a 3D network of interconnected electron-conducting paths; and (iv) at least one of the anode and the cathode comprises particles or fibers of a non-graphene conductive additive and the multiple graphene sheets, in combination with the conductive additive, meet or exceed a percolation threshold defined by a threshold weight percentage or volume percentage of the conductive additive and graphene combined at and above which the graphene sheets and the conductive additive particles or fibers together form a 3D network of interconnected electron-conducting paths.

6. The supercapacitor of claim 1, wherein said graphene sheets are deposited with a nano-scaled coating or particles of a redox pair partner selected from an intrinsically conductive polymer, a transition metal oxide, and/or an organic molecule, wherein said redox pair partner and said graphene sheets form a redox pair for pseudo-capacitance.

7. The supercapacitor of claim 6, wherein said intrinsically conducting polymer is selected from polyaniline, polypyrrole, polythiophene, polyfuran, sulfonated polyaniline, sulfonated polypyrrole, sulfonated polythiophene, sulfonated polyfuran, sulfonated polyacetylene, or a combination thereof.

8. The supercapacitor of claim 1, wherein said electrolyte contains an aqueous electrolyte, an organic electrolyte, a polymer gel electrolyte, a solid polymer electrolyte, an inorganic electrolyte, an ionic liquid electrolyte, or a mixture thereof.

9. The supercapacitor of claim 1, wherein said electrolyte contains an aqueous electrolyte comprising an ion-forming substance dissolved in water, wherein the ion-forming substance is selected from KOH, KCl, H₂SO₄, quaternary phosphonium salts, sodium perchlorate (NaClO₄), Na₂SO₄, a combination thereof, or a combination thereof with a redox active substance.

10. The supercapacitor of claim 9, wherein said redox active substance is selected from the group consisting of iron-based organic complexes, quinones, viologens, phenazines, phenothiazines, 2,2,6,6-tetramethyl-1-piperidinyloxy (TEMPO) derivatives, azobenzenes, alloxazines, and combinations thereof.

11. The supercapacitor of claim 1, wherein both the anode and the cathode contain graphene sheets spaced by cement or concrete and the graphene sheets have a specific surface area from 50 to 3,300 m²/g.

12. The supercapacitor of claim 1, wherein at least one of the anode and the cathode further comprises a carbon or graphite material selected from natural graphite, artificial graphite, expanded graphite, meso-phase carbon, meso-phase pitch, meso-carbon micro-bead, soft carbon, hard carbon, coke, carbon fiber, carbon nano-fiber, carbon nano-tube, activated carbon, carbon black, acetylene black, or a combination thereof and wherein the sum of graphene sheets and the carbon or graphite material is from 10% to 95% by weight of the electrode

13. A supercapacitor electrode containing contains 0.001% to 95% by weight of multiple graphene sheets that are spaced by or dispersed in a cement or concrete and the graphene sheets, when measured alone without the presence of cement or concrete, have a specific surface area from 50 to 3,300 m²/g.

14. The supercapacitor electrode of claim 13, wherein the electrode exhibits at least one of the features below: (i) the electrode is porous and has a specific surface area of from 50 m²/g to 2,000 m²/g; (ii) the electrode has pores that are interconnected or are conducive to permeation of liquid electrolyte and the electrolyte is present in the pores; (iii) the multiple graphene sheets meet or exceed a percolation threshold defined by a threshold weight percentage or volume percentage at and above which the graphene sheets form a 3D network of interconnected electron-conducting paths; and (iv) the electrode comprises particles or fibers of a non-graphene conductive additive and the multiple graphene sheets, in combination with the conductive additive, meet or exceed a percolation threshold defined by a threshold weight percentage or volume percentage of the conductive additive and graphene combined at and above which the graphene sheets and the conductive additive particles or fibers together form a 3D network of interconnected electron-conducting paths.

15. The supercapacitor electrode of claim 13, further containing a liquid or gel electrolyte residing in a space between graphene sheets.

16. The supercapacitor electrode of claim 13, wherein said graphene sheets are selected from a pristine graphene or a non-pristine graphene material, having a content of non-carbon elements from 1% to 50% by weight, selected from graphene oxide, reduced graphene oxide, graphene fluoride, graphene chloride, graphene bromide, graphene iodide, hydrogenated graphene, hydroxylated graphene, nitrogenated graphene, chemically functionalized graphene, doped graphene, or a combination thereof.

17. The supercapacitor electrode of claim 13, wherein said graphene sheets are deposited with a nano-scaled coating or particles of a redox pair partner selected from an intrinsically conductive polymer, a transition metal oxide, and/or an organic molecule, wherein said redox pair partner and said graphene sheets form a redox pair for pseudo-capacitance.

18. The supercapacitor electrode of claim 17, wherein said intrinsically conducting polymer is selected from polyaniline, polypyrrole, polythiophene, polyfuran, sulfonated polyaniline, sulfonated polypyrrole, sulfonated polythiophene, sulfonated polyfuran, sulfonated polyacetylene, or a combination thereof.

19. The supercapacitor electrode of claim 13, wherein said electrode further comprises a carbon or graphite material selected from natural graphite, artificial graphite, expanded graphite, meso-phase carbon, meso-phase pitch, meso-carbon micro-bead, soft carbon, hard carbon, coke, carbon fiber, carbon nano-fiber, carbon nano-tube, activated carbon, carbon black, acetylene black, or a combination thereof and wherein the sum of graphene sheets and the carbon or graphite material is from 10% to 95% by weight of the electrode.

20.-26. (canceled)

27. The supercapacitor of claim 1, further including an ion-permeable separator disposed between said anode and said cathode.
